(19) United States
(12) Patent Application Publication
(10) Pub. No.: US 2007/0191017 A1
(43) Pub. Date: Aug. 16, 2007

(54) Apparatus and method for simultaneously receiving two neighboring frequency assignments in a cellular system

(75) Inventors: Ki-Young Han, Yongin-si (KR); Yong-Seok Kim, Suwon-si (KR); Young-Hoon Kwon, Seongnam-si (KR); Soon-Young Yoon, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/698,288

(22) Filed: Jan. 25, 2007

(30) Foreign Application Priority Data
Jan. 25, 2006 (KR) 2006-0007636

(51) Int. Cl. H04Q 7/20

(52) U.S. Cl. 455/442

(57) ABSTRACT

An apparatus and method for allocating a frequency band to an MS in a cellular system with a frequency reuse factor of N are provided, in which a frequency allocator determines whether the MS receives data simultaneously from two BSs using neighboring FAs and allocates a frequency band to the MS according to the determination, and a subcarrier mapper maps the data to subcarriers according to the frequency band allocated to the MS.

### PRIORITY

This application claims priority under 35 U.S.C. § 119 to an application filed in the Korean Intellectual Property Office on Jan. 25, 2006 and assigned Ser. No. 2006-7636, the contents of which are incorporated herein by reference.

### BACKGROUND OF THE INVENTION

1. Field of the Invention

The present invention relates generally to a cellular communication system, and in particular, to an apparatus and method for allocating a frequency band in which data can be received from two Base Stations (BSs) using neighboring Frequency Assignments (FAs) in a cellular system with a frequency reuse factor of N.

2. Description of the Related Art

The concept “cellular system” was introduced to overcome limits on service coverage and the capacity of accommodating subscribers. In a cellular system, a service area is divided into a plurality of small-size areas called cells, for communications and frequencies are spatially reused by allocating the same frequency band to two cells sufficiently apart from each other. Therefore, the cellular system enables accommodation of a large number of subscribers by increasing the number of spatially distributed channels.

FIG. 1 illustrates a typical cellular system in which a Mobile Station (MS) communicates with a BS.

Referring to FIG. 1, a first MS 103 (MS 1) within the service area 102 of a first BS 101 (BS 1) using a first FA 111 (FA 1) communicates with BS 1 by FA 1. A second MS 107 (MS 2) within the service area 106 of a second BS 105 (BS 2) using a second FA 115 (FA 2) communicates with BS 2 by FA 2. That is, an MS communicates with a BS by an FA supported by the BS.

If BS 1 and BS 2 use neighboring FAs in the above cellular system, frequency bands are allocated to MS 1 and MS 2 in the manner illustrated in FIG. 2.

FIG. 2 illustrates frequency bands allocated to MSs for communications with BSs in the typical cellular system.

Referring to FIG. 2, since MS 1 and MS 2 use neighboring FAs, guard bands 203, 205, 213 and 215 are used to avoid interference between the neighboring FAs. No data is delivered in the guard bands 203, 205, 213 and 215 and thus MS 1 and MS 2 send data in frequency bands 201 and 211 except the guard bands 203, 205, 213 and 215.

As described above, an MS within the service area of a BS communicates using the FA of the BS. Especially, if the MS is located at a cell boundary between two BSs, i.e. in a handover region and thus can receive signals from the two BSs, it communicates using the FA of one of the BSs that offers stronger reception power. Even though the two BSs provide similar reception power, the MS cannot receive data from the two BSs simultaneously.

Accordingly, there exists a need for developing a technique for receiving data from two BSs using neighbor FAs at the same time.

### SUMMARY OF THE INVENTION

An object of the present invention is to substantially solve at least the above problems and/or disadvantages and to provide at least the advantages below. Accordingly, an object of the present invention is to provide an apparatus and method for simultaneously receiving data from BSs using neighboring FAs in a cellular system.

Another object of the present invention is to provide an apparatus and method for allocating a frequency band to an MS in which the MS can simultaneously receive data from BSs using neighboring FAs in a cellular system.

In accordance with an aspect of the present invention, there is provided an apparatus of a BS for allocating a frequency band in a cellular system with a frequency reuse factor of N, in which a frequency allocator determines whether an MS to which data is to be transmitted receives data simultaneously from the BS using a first FA and a BS using a second FA neighboring to the first FA and allocates a frequency band to the MS according to the determination, and a subcarrier mapper maps the data to subcarriers according to the frequency band allocated to the MS.

In accordance with another aspect of the present invention, there is provided a method of a BS for allocating a frequency band in a cellular system with a frequency reuse factor of N, in which the BS determines whether an MS to which data is to be transmitted receives data simultaneously from the BS using a first FA and a BS using a second FA neighboring to the first FA, checks the direction of the second FA with respect to the first FA, if the MS receives data simultaneously from the BSs using the neighboring first and second FAs, and allocates part of the first FA to the MS according to the direction of the second FA with respect to the first FA.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a typical cellular system in which an MS communicates with a BS;

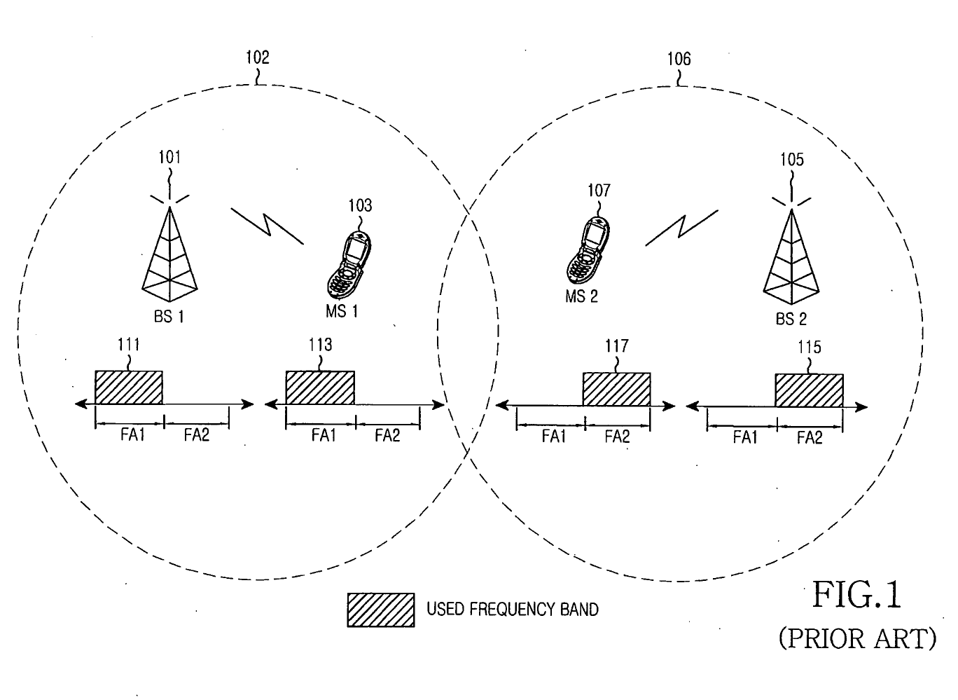

FIG. 2 illustrates frequency bands allocated to MSs for communications with BSs in the typical cellular system;

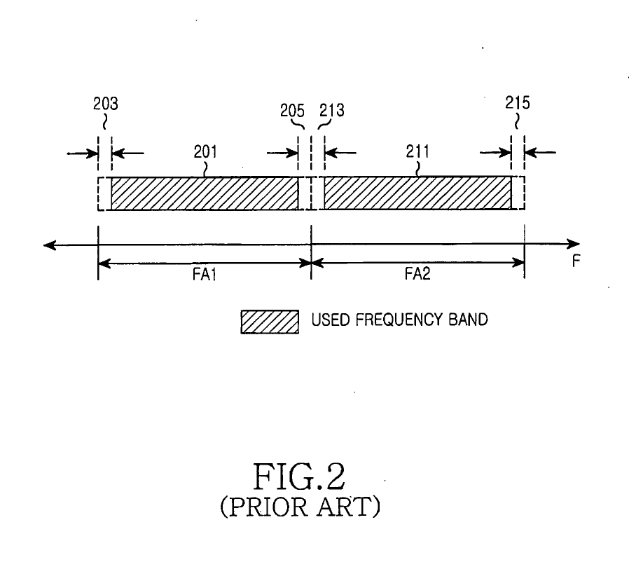

FIG. 3 illustrates a structure in which an MS receives data from two BSs using neighboring FAs simultaneously according to the present invention;

FIGS. 4A and 4B illustrate a frequency band allocated to an MS in which the MS can receive data simultaneously from two BSs using neighboring FAs according to the present invention;

FIG. 5 illustrates a frequency band allocated to an MS in which the MS can receive data simultaneously from two BSs using neighboring FAs according to the present invention;

FIG. 6 is a block diagram of a BS transmitter for allocating a frequency band to an MS in which the MS can receive data simultaneously from two BSs using neighboring FAs according to the present invention; and

FIG. 7 is a flowchart illustrating an operation for allocating a frequency band to an MS in which the MS can receive data simultaneously from two BSs using neighboring FAs according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention is intended to provide a technique for allocating a frequency band to an MS in which the MS can receive data simultaneously from two BSs using neighboring FAs in a cellular system. A BS allocates a frequency band to an MS, for communications between them.

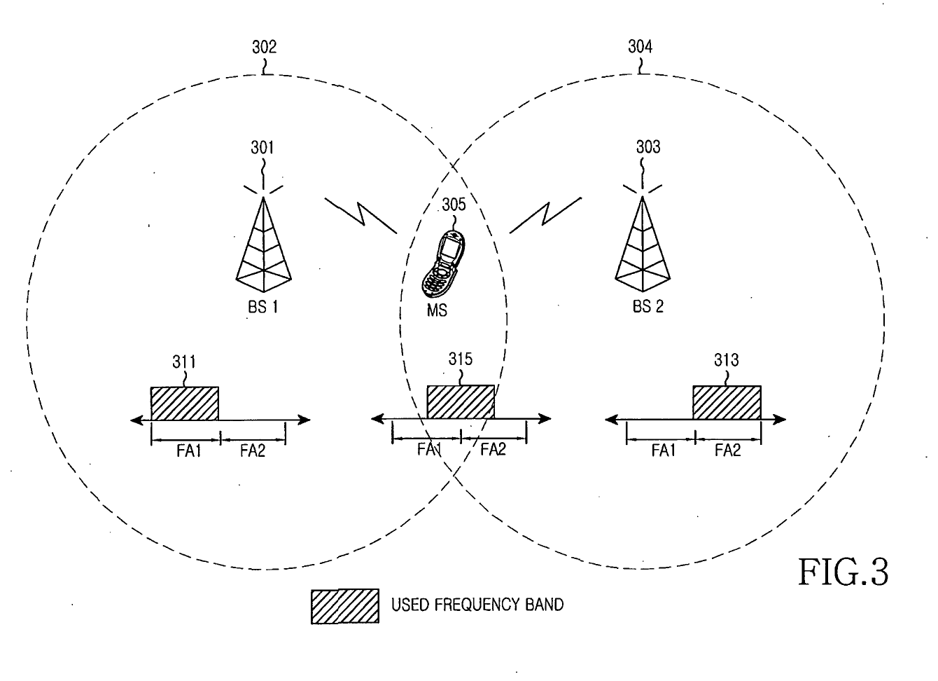

FIG. 3 illustrates a structure in which an MS receives data from two BSs using neighboring FAs simultaneously according to the present invention. In the illustrated case of FIG. 3, two BSs 301 and 303 (BS1 and BS 2) use neighboring FAs.

Referring to FIG. 3, when an MS 305 is located within the service area 302 of BS 1, it communicates with BS 1 by a first FA 311 (FA 1), and when the MS 305 is located within the service area 304 of BS 2, it communicates with BS 2 by a second FA 313 (FA 2).

As the MS 305 moves to the cell boundary between BS 1 and BS 2, i.e. a handover region, it can receive data simultaneously from BS 1 and BS 2 using a frequency band 315 formed by a segment of FA 1 and a segment of FA 2.

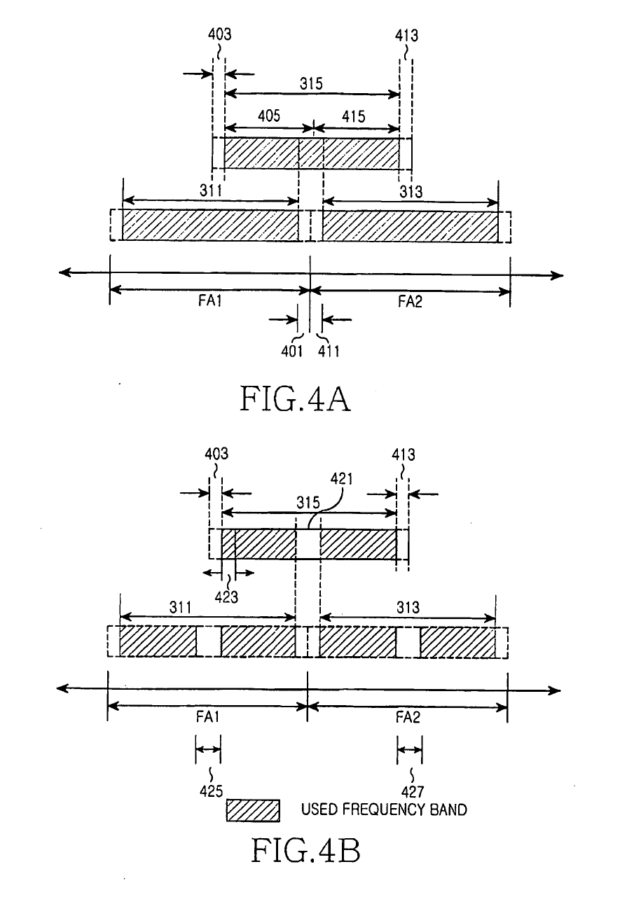

For simultaneous data reception from BS 1 and BS 2 using the neighboring FAs, the MS 305 is allocated the frequency band from BS 1 and BS 2 as illustrated in FIGS. 4A and 4B.

FIGS. 4A and 4B illustrate a frequency band allocated to an MS in which the MS can receive data simultaneously from two BSs using neighboring FAs according to the present invention.

Referring to FIG. 4A, the MS 305 of FIG. 3 receives data from BS 1 and BS 2 at the same time in the frequency band 315 being segments of FA 1 and FA 2. The frequency band 315 includes guard bands 403 and 413 to mitigate interference from other neighboring frequency bands.

As described above, BS 1 and BS 2 allocate segments of FA 1 and FA 2 to the MS 305, for communications. For example, BS 1 allocates a frequency band 405 to the MS 305 for communications between the MS 305 and BS 1 and BS 2 allocates a frequency band 415 to the MS 305 for communications between the MS 305 and BS 2. Thus, the MS 305 simultaneously receives data from the two BSs using the frequency bands 405 and 415.

However, communications using segments of two neighboring FAs as illustrated in FIG. 4A leads to a decrease in the resource use efficiency of the whole system, as depicted in FIG. 4B.

For example, FA 1 and FA 2 have guard bands 401 and 411 to reduce interference. Since BS 1 and BS 2 send/receive no data in the guard bands 401 and 411, the MS 305 does not use a band 421 of the frequency band 315.

The frequency band 315 also has its guard bands 403 and 413. Hence, center bands 425 and 427 of frequency bands 311 and 313 are not available. If BS 1 allocates data to the guard band 403 of the MS 305, a frequency band 423 neighboring to the guard band 403 suffers from aliasing, thereby causing signal distortion.

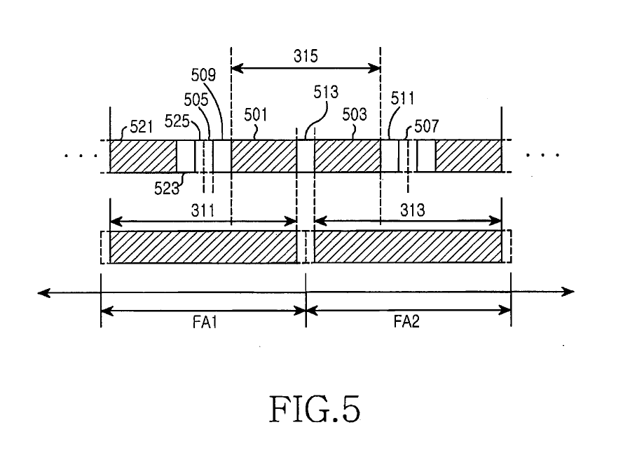

Therefore, a frequency band allocation method described in FIG. 5 is required to allow the MS 305 to simultaneously receive data from BS 1 and BS 2, while reducing the decrease of the resource efficiency of the whole system.

FIG. 5 illustrates a frequency band allocated to an MS in which the MS can receive data simultaneously from two BSs using neighboring FAs according to the present invention.

Referring to FIG. 5, the MS 305 simultaneously receives data from BS 1 and BS 2 in the frequency band 315 being segments of FA 1 and FA 2.

No data is delivered in guard bands 505 and 507 of the frequency band 315 and a guard band 513 between FA 1 and FA 2. No data is carried in anti-aliasing bands 509 and 511 for preventing aliasing of FA 1 and FA 2. Hence, actual data is sent in frequency bands 501 and 503 except the above bands. The sum of the bandwidths of the band 505 and a band 525 is equal to the bandwidth of the guard band 513. The bandwidth of each of the anti-aliasing bands 509, 511 and 523 is equal to that of the guard band 513.

That is, to enable the MS 305 to receive data from BS 1 and BS 2 simultaneously, BS 1 and BS 2 allocate the frequency bands 501 and 503 to the MS 305, respectively.

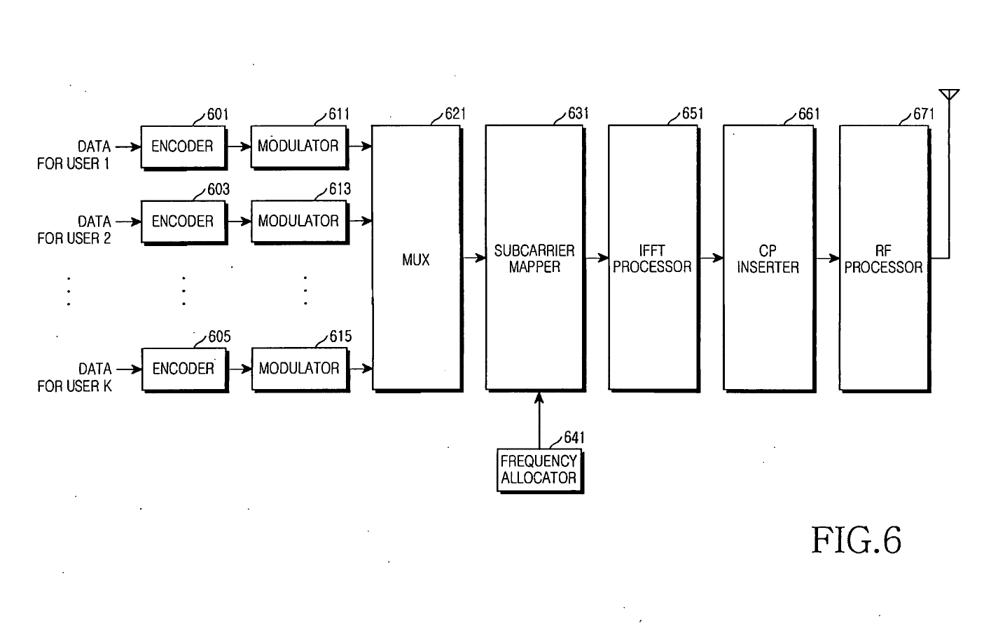

FIG. 6 is a block diagram of a BS transmitter for allocating a frequency band to an MS in which the MS can receive data simultaneously from two BSs using neighboring FAs according to the present invention.

Referring to FIG. 6, the BS transmitter includes encoders 601, 603 and 605, modulators 611, 613 and 615, a Multiplexer (MUX) 621, a subcarrier mapper 631, a frequency allocator 641, an Inverse Fast Fourier Transform (IFFT) processor 651, a Cyclic Prefix (CP) inserter 661, and a Radio Frequency (RF) processor 671.

The encoders 601, 603 and 605 channel-encode data for users to be sent in multiple paths. The modulators 611, 613 and 615 modulate the coded data in a predetermined modulation scheme such as Binary Phase Shift Keying (BPSK), Quadrature Phase Shift Keying (QPSK), 16-ary Quadrature Amplitude Modulation (16QAM), or 64-ary QAM (64QAM).

The MUX 621 channel-multiplexes the modulated data. The subcarrier mapper 631 maps the multiplexed data to subcarriers of a frequency band allocated by the frequency allocator 641.

The frequency allocator 641 determines band sliding of an MS and correspondingly allocates a frequency band. Referring to FIG. 5, for example, if an MS communicating with BS 1 does not perform band sliding, BS 1 allocates FA 1 to the MS. If the MS performs band sliding to the right, BS 1 allocates the frequency band 501 to the MS. If the MS performs band sliding to the left, BS 1 allocates a frequency band 521 to the MS. Band sliding a handoff scheme in which the use frequency band of an MS shifts so that the MS can receive data simultaneously from two BSs using neighboring FAs.

The IFFT processor 651 converts the frequency-domain data received from the subcarrier mapper 631 to time sample data by IFFT.

The CP inserter 661 inserts a CP in the IFFT data to eliminate Inter-Symbol Interference (ISI) caused by multipath fading of a radio channel.

The RF processor 671 converts the digital signal received from the CP inserter 661 to an analog signal, upconverts the analog baseband signal to an RF signal, and sends the RF signal through an antenna.

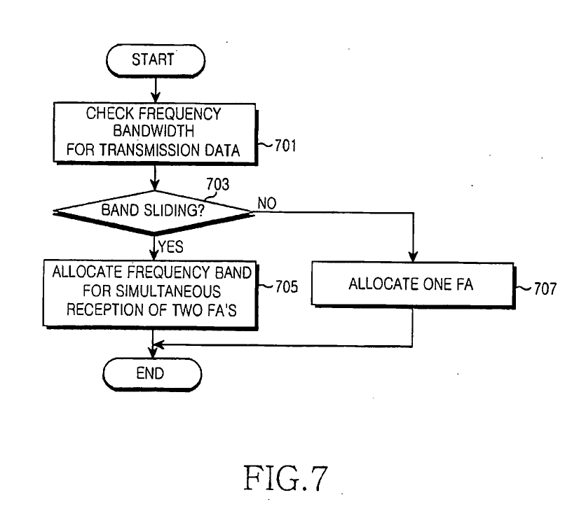

FIG. 7 is a flowchart illustrating an operation for allocating a frequency band to an MS in which the MS can receive data simultaneously from two BSs using neighboring FAs according to the present invention.

Referring to FIG. 7, the BS checks a frequency bandwidth for transmission data for the MS in step 701 and determines whether the MS has performed band sliding in step 703.

In case of the band sliding, the BS allocates a segment of its FA to the MS according to the direction of the band sliding in step 705. For example, if an MS under coverage of BS 1 has performed band sliding to the right, BS 1 allocates the frequency band 501 to the MS. In case of a left band sliding, BS 1 allocates the frequency band 521 to the MS in FIG. 5.

Without the band sliding in the MS, the BS allocates its FA to the MS in step 707. For example, BS 1 allocates the frequency band 311 to the MS.

Then, the BS ends the algorithm of the present invention.

In the case where an MS that performs band sliding and an MS that does not band sliding coexist under the BS, the BS allocates a frequency band to the latter MS with priority.

As is apparent from the above description, the present invention reduces an aliasing-caused decrease in frequency resource efficiency and achieves a diversity effect by allocating a frequency band to an MS in which the MS can receive data simultaneously from two BSs using neighboring FAs in a cellular system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus of a Base Station (BS) for allocating a frequency band in a cellular system with a frequency reuse factor of N, comprising:
a frequency allocator for determining whether a Mobile Station (MS) to which data is to be transmitted is able to receive data simultaneously from the BS using a first Frequency Assignment (FA) and a BS using a second FA neighboring to the first FA and allocating a frequency band to the MS according to the determination; and
a subcarrier mapper for mapping the data to subcarriers according to the frequency band allocated to the MS.

2. The apparatus of claim 1, wherein the frequency allocator comprises:
a decider for determining whether the MS receives data simultaneously from the BSs using the neighboring first and second FAs; and
an allocator for allocating the frequency band to the MS according to the determination.

3. The apparatus of claim 2, wherein if the MS receives data simultaneously from the BSs using the neighboring first and second FAs, the frequency allocator checks the direction of the second FA with respect to the first FA and allocates part of the first FA to the MS according to the direction of the second FA with respect to the first FA.

4. The apparatus of claim 3, wherein the frequency band allocated to the MS includes a guard band, an anti-aliasing band, a data transmission band, and a guard band of the first FA.

5. The apparatus of claim 2, wherein if the MS does not receive data simultaneously from the BSs using the neighboring first and second FAs, the frequency allocator allocates the first FA to the MS.

6. The apparatus of claim 5, wherein the frequency band allocated to the MS includes a guard band and a data transmission band.

7. The apparatus of claim 1, wherein the frequency allocator allocates a frequency band to an MS that does not receive data simultaneously from the BSs using the neighboring first and second FAs, with priority.

8. A method of a Base Station (BS) for allocating a frequency band in a cellular system with a frequency reuse factor of N, comprising:
determining whether a Mobile Station (MS) to which data is to be transmitted is able to receive data simultaneously from the BS using a first Frequency Assignment (FA) and a BS using a second FA neighboring to the first FA;
checking the direction of the second FA with respect to the first FA, if the MS receives data simultaneously from the BSs using the neighboring first and second FAs; and
allocating part of the first FA to the MS according to the direction of the second FA with respect to the first FA.

9. The method of claim 8, further comprising allocating the first FA to the MS, if the MS does not receive data simultaneously from the BSs using the neighboring first and second FAs.

10. The method of claim 9, wherein the first FA allocated to the MS includes a guard band and a data transmission band.

11. The method of claim 8, wherein the allocation comprises allocating a frequency band to an MS that does not receive data simultaneously from the BSs using the neighboring first and second FAs, with priority.

12. The method of claim 8, wherein the allocation comprises:
allocating a right part of the first FA of the BS to the MS, if the second FA is to the right of the first FA; and
allocating a left part of the first FA of the BS to the MS, if the second FA is to the left of the first FA.

13. The method of claim 12, wherein the frequency band allocated to the MS includes a guard band, an anti-aliasing band, a data transmission band, and a guard band of the first FA.

14. A Base Station (BS) for allocating a frequency band in a cellular system, comprising:
a frequency allocator for determining whether a Mobile Station (MS) to which data is to be transmitted is performing a band sliding and allocating a frequency band to the MS according to the determination; and
a subcarrier mapper for mapping the data to subcarriers according to the frequency band allocated to the MS.

15. The Base Station(BS) of claim 14, wherein the frequency allocator comprises:
a decider for determining whether the MS performs the band sliding; and
an allocator for allocating the frequency band to the MS according to the determination.

16. A method of a Base Station (BS) for allocating a frequency band in a cellular system, comprising:
determining whether a Mobile Station (MS) to which data is to be transmitted is able to receive data simultaneously from the BS using a first Frequency Assignment (FA) and a BS using a second FA neighboring to the first FA;
allocating a frequency band to the MS according to the determination; and
mapping the data to subcarriers according to the frequency band allocated to the MS.

17. A method of a Base Station (BS) for allocating a frequency band in a cellular system, comprising:
determining whether a Mobile Station (MS) to which data is to be transmitted is performing a band sliding;
allocating a frequency band to the MS according to the determination; and
mapping the data to subcarriers according to the frequency band allocated to the MS.

18. A Base Station (BS) for allocating a frequency band in a cellular system, comprising:
means for determining whether a Mobile Station (MS) to which data is to be transmitted is able to receive data simultaneously from the BS using a first Frequency Assignment (FA) and a BS using a second FA neighboring to the first FA;
means for checking the direction of the second FA with respect to the first FA, if the MS receives data simultaneously from the BSs using the neighboring first and second FAs; and
means for allocating part of the first FA to the MS according to the direction of the second FA with respect to the first FA.

19. The Base Station (BS) of claim 18, further comprising means for allocating the first FA to the MS, if the MS does not receive data simultaneously from the BSs using the neighboring first and second FAs.

20. The Base Station (BS) of claim 19, wherein the first FA allocated to the MS includes a guard band and a data transmission band.
